(19) United States
(12) Patent Application Publication
(10) Pub. No.: US 2026/0290968 A1
(43) Pub. Date: Sep. 24, 2026

(54) REDUCING HUMIDITY WITHIN BATTERY PACKS

(71) Applicant: GM GLOBAL TECHNOLOGY OPERATIONS LLC, Detroit, MI (US)

(72) Inventors: Amogh Deo, Rochester, MI (US); Ryan Patrick Hickey, New York, NY (US); Roshan Kandanda, Sterling Heights, MI (US)

(73) Assignee: GM GLOBAL TECHNOLOGY OPERATIONS LLC, Detroit, MI (US)

(21) Appl. No.: 19/085,219

(22) Filed: Mar. 20, 2025

(51) Int. Cl. H01M 50/233; H01M 10/48; H01M 10/613; H01M 10/625; H01M 10/6562; H01M 50/249

(52) U.S. Cl. CPC H01M 50/233; H01M 10/488; H01M 10/613; H01M 10/625; H01M 10/6562; H01M 50/249; H01M 2220/20

(57) ABSTRACT

Battery humidity reduction system for vehicles and methods for reducing humidity in battery packs are provided. A method includes locating a battery module within an interior volume of a battery enclosure having a floor and configured to be enclosed with a cover;locating a desiccant within the interior volume of the battery enclosure; andabsorbing water from air within the interior volume of the battery enclosure.

### INTRODUCTION

The disclosure relates generally to electric drive vehicles, including full electric and hybrid electric configurations. More specifically, aspects of this disclosure relate to battery enclosures for battery packs of battery electric vehicles (BEV).

Humidity within battery enclosures may be undesirable. For example, humidity may cause condensation of water. The presence of water near components at risk for loss of isolation (LOI) is particularly undesirable.

Accordingly, there is a need for the reduction of humidity within battery enclosures. Also, it is desirable to provide for the reduction of humidity within battery enclosures using components that may be serviced or replaced without detaching and/or removing the battery enclosure from the vehicle. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a method for reducing humidity in a battery pack is provided. The method includes locating a battery module within an interior volume of a battery enclosure having a floor and configured to be enclosed with a cover; locating a desiccant within the interior volume of the battery enclosure; and absorbing water from air within the interior volume of the battery enclosure.

In certain embodiments, the method further includes removing the desiccant from the interior volume of the battery enclosure; and inserting fresh desiccant into the interior volume of the battery enclosure, and the battery module remains within the interior volume of the enclosure while removing the desiccant and inserting the fresh desiccant.

In certain embodiments of the method, the floor of the enclosure is supported by a lower cross beam; a stanchion is mounted to the lower cross beam and extends through the interior volume of the battery enclosure to an upper cross beam; the stanchion includes a stanchion wall surrounding a channel; the stanchion wall is formed with at least one port providing fluid communication between the channel and the interior volume of the battery enclosure; and locating the desiccant within the interior volume of the battery enclosure includes inserting the desiccant into the channel of the stanchion.

In certain embodiments of the method, an indicator in contact with the desiccant is visible at a top end of the stanchion, and the method further includes providing an indication, external of the battery enclosure, with the indicator that the desiccant should be replaced.

In certain embodiments of the method, the battery pack is located in a vehicle having a cabin with a cabin floor, the indicator is visible at the cabin floor, and the method further includes pulling the desiccant from the channel of the stanchion into the vehicle cabin; and inserting fresh desiccant into the channel of the stanchion from the vehicle cabin.

In certain embodiments, the method further includes calculating with a processor that the desiccant should be replaced, based on an amount of the desiccant located within the interior volume of the battery enclosure, based on a performance efficiency of the desiccant, based on an external humidity of an external environment, and based on a period of time that the battery pack has been exposed to the external environment.

In certain embodiments of the method, the processor activates an alert providing an indication that the desiccant should be replaced.

In certain embodiments of the method, the enclosure is formed with a vent defining an airflow channel, and locating the desiccant within the interior volume of the battery enclosure includes locating the desiccant across the airflow channel.

In certain embodiments, the method further includes locating a baffle within the battery enclosure to redirect a flow of air into the interior volume through the vent; and cooling the baffle to condense water from the air.

In certain embodiments, the method further includes locating a closable baffle across the airflow channel; determining that the desiccant needs to be regenerated; closing the closable baffle to close the airflow channel; heating the desiccant to evaporate water therefrom and regenerate the desiccant; and re-opening the closable baffle after the desiccant is regenerated.

In another embodiment, a battery humidity reduction system is provided for a vehicle. The system includes a battery enclosure; a battery module located within the battery enclosure; a lower cross beam connected to a structure of the vehicle and located below the battery enclosure; an upper cross beam connected to the structure of the vehicle and located above the battery enclosure; a structural stanchion interconnected between the lower cross beam and the upper cross beam, wherein the structural stanchion interconnected passes through the battery enclosure, the structural stanchion is formed with a stanchion wall surrounding an inner channel, and the stanchion wall is formed with a window; and desiccant located in a desiccant cartridge configured to be inserted into and withdrawn from the inner channel of the structural stanchion.

In certain embodiments of the battery humidity reduction system, the desiccant cartridge holds an indicator that provides a visual indication when the desiccant needs to be replaced.

In certain embodiments of the battery humidity reduction system, the battery enclosure is located below a vehicle cabin floor of a vehicle cabin, and the system further includes an opening in the vehicle cabin floor configured for insertion of the cartridge from the vehicle cabin into the inner channel of the stanchion.

In certain embodiments of the battery humidity reduction system, the indicator is visible from the vehicle cabin when the desiccant is located in the inner channel.

In another embodiment, a vehicle is provided and includes an electric propulsion system; a battery module; a battery enclosure received within the battery enclosure, wherein the battery enclosure is formed with a vent that defines an airflow channel; and desiccant extending across the airflow channel.

In certain embodiments, the vehicle includes a baffle within the battery enclosure to redirect a flow of air into the interior volume through the vent.

In certain embodiments, the vehicle includes a cooler in contact with the baffle and configured to cool the baffle to cause condensation of water thereon.

In certain embodiments, the vehicle includes a mesh extending across the airflow channel and located below the baffle, wherein the mesh is configured to collect water from the baffle, and the desiccant is located within the mesh.

In certain embodiments, the vehicle includes a closable baffle extending across the airflow path, and the closable baffle is located between the desiccant and a remaining internal volume of the battery enclosure.

In certain embodiments, the vehicle includes a controller configured to determine when the desiccant needs to be regenerated; close the closable baffle; activate heating of the desiccant to evaporate water therefrom to regenerate the desiccant; and re-open the closable baffle after regeneration of the desiccant.

### DESCRIPTION OF THE DRAWINGS

The present disclosure will hereinafter be described in conjunction with the following drawing figures, wherein like numerals denote like elements, and wherein:

FIG. 1 is a schematic top view of an embodiment of a vehicle with a battery module in a battery enclosure, according to various embodiments.

FIG. 2 is a schematic cross-sectional side view of a portion of the battery enclosure shown in FIG. 1, wherein desiccant is located within the battery enclosure to reduce humidity therein, according to various embodiments.

FIG. 3 is a schematic cross-sectional side view of a portion of the battery enclosure shown in FIG. 1, wherein desiccant is located within the battery enclosure to reduce humidity therein, according to various embodiments.

FIG. 4 is a schematic cross-sectional side view of a portion of the battery enclosure shown in FIG. 1, wherein desiccant is located within the battery enclosure to reduce humidity therein, according to various embodiments.

FIG. 5 is a schematic cross-sectional side view of a portion of the battery enclosure shown in FIG. 1, wherein desiccant is located within an airflow channel into the battery enclosure to reduce humidity therein, according to various embodiments.

### DETAILED DESCRIPTION

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment. It should also be understood that the figures are merely illustrative and may not be drawn to scale, and may not show proportions between different drawn elements.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

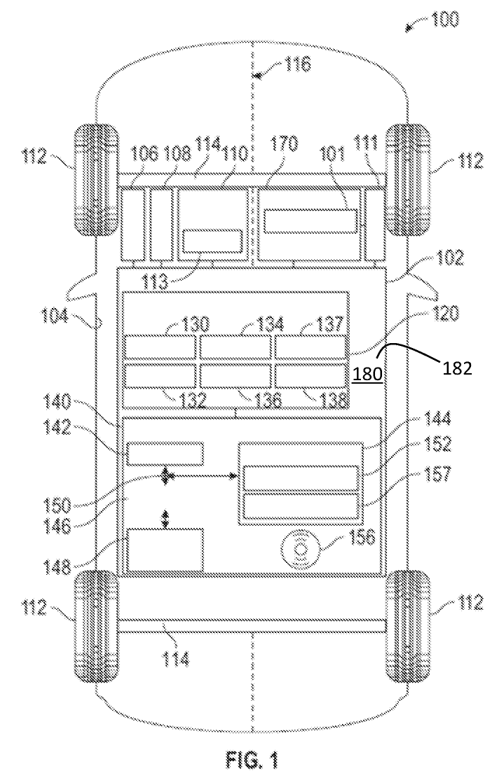

FIG. 1 illustrates a vehicle 100, according to an exemplary implementation. It is noted that FIG. 1 is merely illustrative and not drawn to scale, and is not intended to show proportions between different drawn elements. As described in greater detail further below, the vehicle 100 includes, among other components, a rechargeable energy storage system (“RESS”) 101 and a control system 102. In various implementations, the RESS 101 includes a plurality of battery cells in battery groups. Also in various implementations, the control system 102 controls the RESS 101.

As depicted in FIG. 1, the RESS 101 and control system 102 are depicted as part of the vehicle 100 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform). In yet other implementations, the RESS 101 and control system 102 may instead be part of and/or coupled to any number of other types of platforms and/or other systems, moving or non-moving, such as a building, infrastructure, secondary use, home power, non-automotive, and/or other platforms and/or other systems.

In the depicted implementation, the vehicle 100 includes a body 104 that is arranged on a chassis 116. The chassis 116 may include a frame and suspension systems. The vehicle 100 includes a passenger cabin 180 over a cabin floor 182. The body 104 substantially encloses other components of the vehicle 100. The body 104 and the chassis 116 may jointly form a frame. In a unibody design, the frame and body 104 are an integral unit.

The vehicle 100 also includes a plurality of wheels 112. The wheels 112 are each rotationally coupled to the chassis 116 near a respective corner of the body 104 to facilitate movement of the vehicle 100. In one implementation, the vehicle 100 includes four wheels 112, although this may vary in other implementations (for example for trucks, motorcycles, and certain other vehicles).

A drive system 110 is mounted on the chassis 116, and drives the wheels 112, for example via axles 114. In certain implementations, the drive system 110 comprises a propulsion system having an electric motor 113. In various implementations, the drive system 110, including the motor 113, receives high voltage from the RESS 101.

In various implementations, in addition to providing the high voltage to the motor 113, the RESS 101 also provides low voltage to one or more low voltage systems 111 of the vehicle 100. In various implementations, the low voltage systems 111 may include, by way of example, one or more climate control systems, radio systems, seat warming systems, and so on.

As depicted in FIG. 1, the vehicle also includes a braking system 106 and a steering system 108 in various implementations. In exemplary implementations, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary implementations, the steering system 108 controls steering of the vehicle 100 via steering components that are controlled via inputs provided by a driver (e.g., via a steering wheel), and/or automatically via a control system (such as the control system 102 and/or one or more other control systems).

In the implementation depicted in FIG. 1, the control system 102 is coupled to the RESS 101, receives inputs therefrom, and controls functionality thereof. In addition, in certain implementations, the control system 102 is coupled to one or more of the braking system 106, steering system 108, drive system 110, and/or low voltage systems 111, and may also receive inputs from and/or control these additional systems in certain implementations.

Also as depicted in FIG. 1, in various implementations, the control system 102 includes a sensor array or arrangement 120 and a control module 140 (or controller), as described in greater detail below.

In various implementations, the sensor array 120 includes various sensors that obtain sensor data of the vehicle 100 for use in controlling, among other functionality, the RESS 101. In the depicted implementation, the sensor array 120 may include one or more voltage sensors 130, current sensors 132, temperature sensors 134, pressure sensors 136, gas sensors 137, and humidity sensors 138.

In various implementations, the control module 140 is coupled to the sensor array 120 and receives sensor data therefrom. In various implementations, the control module 140 is further coupled to the RESS 101. In addition, in certain implementations, the control module 140 may also be coupled to one or more other systems of the vehicle 100, such as the braking system 106, steering system 108, drive system 110, and/or low voltage systems, for example for receiving input thereof and/or for controlling thereof.

As depicted in FIG. 1, in various implementations, the control module 140 comprises a computer system, and includes a processor 142, a memory 144, an interface 146, a storage device 148, and a computer bus 150.

The processor 142 performs the computation and control functions of the control module 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the control module 140 and the computer system of the control module 140, generally in executing the processes described herein.

The memory 144 can be any type of suitable memory, including various types of non-transitory computer readable storage medium. In certain examples, the memory 144 is located on and/or co-located on the same computer chip as the processor 142. In the depicted implementation, the memory 144 stores the above-referenced program 152 along with stored values 157 (e.g., look-up tables, thresholds, and/or other values with respect to control of the RESS 101).

The interface 146 allows communication to the computer system of the control module 140, for example from a system driver and/or another computer system, and can be implemented using any suitable method and apparatus. In one implementation, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

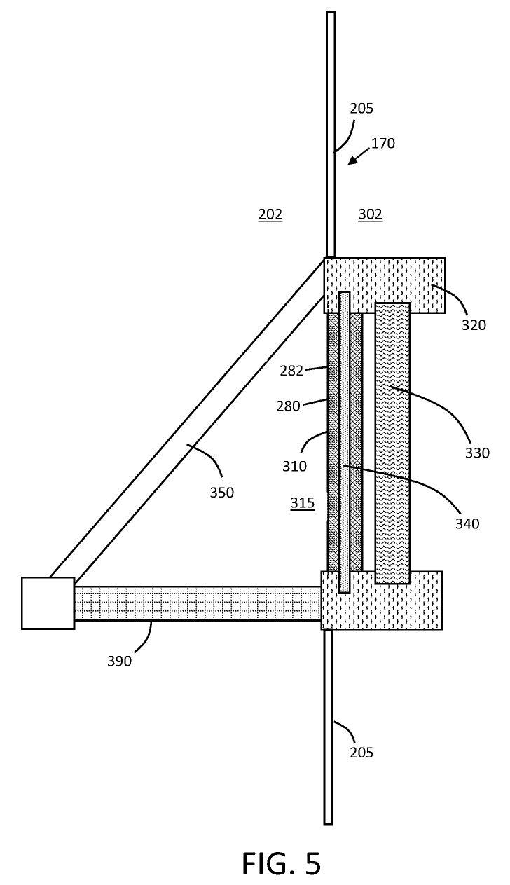

The storage device 148 can be any suitable type of storage apparatus, including various different types of direct access storage and/or other memory devices. In one exemplary implementation, the storage device 148 comprises a program product from which memory 144 can receive a program 152 that executes one or more implementations of one or more processes of the present disclosure, such as the steps of the method 500 of FIG. 5 and described further below in connection therewith. In another exemplary implementation, the program product may be directly stored in and/or otherwise accessed by the memory 144 and/or a disk (e.g., disk 156), such as that referenced below.

The bus 150 serves to transmit programs, data, status and other information or signals between the various components of the computer system of the control module 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

In FIG. 1, the RESS 101 is located within a battery enclosure 170 that may be structurally mounted, directly or indirectly, to the chassis 116. The battery enclosure 170 may be accessible from the cabin 180, such as through the cabin floor 182.

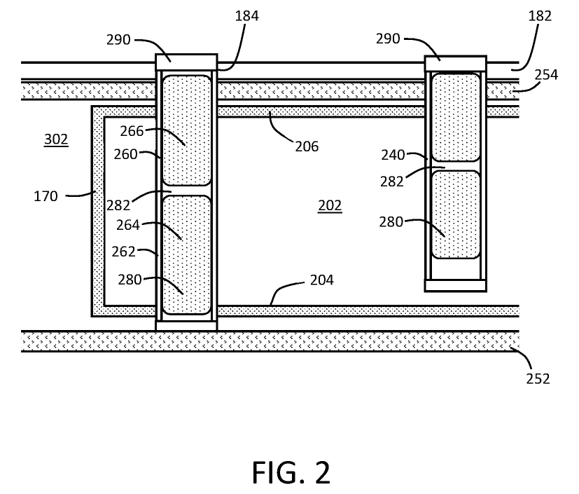

FIG. 2 provides a side cross-sectional schematic view of a portion of the battery enclosure 170 of FIG. 1. The RESS 101 is not illustrated in FIG. 2 and may be located in the illustrated portion of the battery enclosure 170 and/or in a non-illustrated portion of the battery enclosure 170. FIG. 2 illustrates an embodiment of a battery enclosure 170 configured to receive desiccant in an easily removable manner.

The battery enclosure 170 encloses an interior volume 202. Specifically, the battery enclosure 170 separates the interior volume 202 from an external volume 302 outside of the battery enclosure 170. As further shown, the battery enclosure 170 includes a bottom floor structure or tray 204 and an upper cover 206. The tray 204 and cover 206 may be contacted, connected, and sealable to one another. Alternatively, a sidewall or sidewalls may interconnect the tray 204 and cover 206. The battery enclosure may be indirectly mounted to the chassis 116 through the tray 204, through the cover 206, or through the tray 204 and cover 206.

In FIG. 2, a lower structural cross beam 252 is located below the tray 204 of the battery enclosure 170, and may be structurally connected to the chassis 116 (shown in FIG. 1). Likewise, an upper structural cross beam 254 is located above the cover 206 of the battery enclosure 170, and may be structurally connected to the chassis 116 (shown in FIG. 1). Further, the cabin floor 182 is located above the upper structural cross beam 254. The cabin floor 182 may be directly supported by the upper cross beam 254, or indirectly supported by the upper cross beam 254.

As further shown, a stanchion 260 may be provided. The stanchion 260 may be a structural component connected to cross beam 252 under the tray 204 and connected to cross beam 254 over the cover 206. As shown, the stanchion 260 may extend through the battery enclosure 170. Specifically, the stanchion 260 may extend through the tray 204 and through the cover 206. Further, the stanchion 260 may extend through the cabin floor 182, or may be accessible through an opening 184 in the cabin floor 182.

In addition to providing structural support to the vehicle 100, the stanchion 260 serves a second purpose. As shown, the stanchion 260 includes an outer wall 262 that surrounds an inner channel 264. The outer wall 262 is formed with windows or openings 266 to allow for fluid communication between the inner channel 264 and the interior volume 202 of the battery enclosure 170.

As further shown, desiccant 280 is located in the inner channel 264 of the stanchion 260. The desiccant 280 may be any suitable material, such as a silica-based or calcium-based material, and/or a high performance color-changing composition selected for use in typical conditions encountered by the battery enclosure 170.

The desiccant 280 may be positioned in a cartridge 282 or rod structure and may be inserted through the opening 184 in the cabin floor 182 and into the inner channel 264 of the stanchion 260. The desiccant 280 may be in contact with an indicator 290. For example, the indicator 290 may be a color-changing composition. For example, the indicator 290 may change color based on moisture level. Thus, when the desiccant has removed a selected amount of water from the air within the interior volume 202 of the battery enclosure 170, the indicator 290 may reach a moisture level that causes a color change. As shown, the indicator 290 may be located at a top end of the cartridge 282 so that the indicator 290 is visible from the vehicle cabin 180 without removing the cartridge 282.

In certain embodiments, engagement between the desiccant cartridge 282 and the cabin floor 182 is provided to prevent gas from exiting the battery enclosure 202 and entering the vehicle cabin 180. For example, the desiccant cartridge 282 and cabin floor 182 may be threaded to engage one another so that the desiccant cartridge 282 is screwed into connection with the cabin floor 182.

While a single structural stanchion 260 receiving desiccant 280 is illustrated, embodiments may provide for any suitable number of structural stanchions 260 receiving desiccant 280

In addition to insertion of desiccant 280 into structural stanchions 260, embodiments may provide for the addition of desiccant at other locations of the battery enclosure 170.

For example, it may be determined that condensation is more likely to occur at, and/or is more of a concern at, locations such as the front headers, rear headers, battery disconnect unit (BDU) connects, or other locations in the battery enclosure 170. Thus, non-structural stanchions 240 may be inserted at the identified locations. As shown, the non-structural stanchion 240 may not extend through the tray 204 of the battery enclosure 170. Specifically, the non-structural stanchion 240 may extend through the cover 206. Further, the non-structural stanchion 240 may extend through the cabin floor 182, or may be accessible through an opening 184 in the cabin floor 182.

Similar to stanchion 240, the non-structural stanchion 240 includes an outer wall that surrounds an inner channel. The outer wall is formed with windows or openings to allow for fluid communication between the inner channel and the interior volume 202 of the battery enclosure 170.

As further shown, desiccant 280 is located in the inner channel of the non-structural stanchion 240, such as via a desiccant cartridge 282, as described above in relation to stanchion 260. Also, an indicator 290 may be located at the top end of the cartridge 282 as described above.

Use of the non-structural stanchion 240 may provide for selectively locating desiccant 280 at any desired location within the internal volume 202 of the battery enclosure 170 regardless of the location of structural stanchions 260. Further, any desired number of non-structural stanchions 240 may be used to provide the desired amount of water removal and humidity reduction.

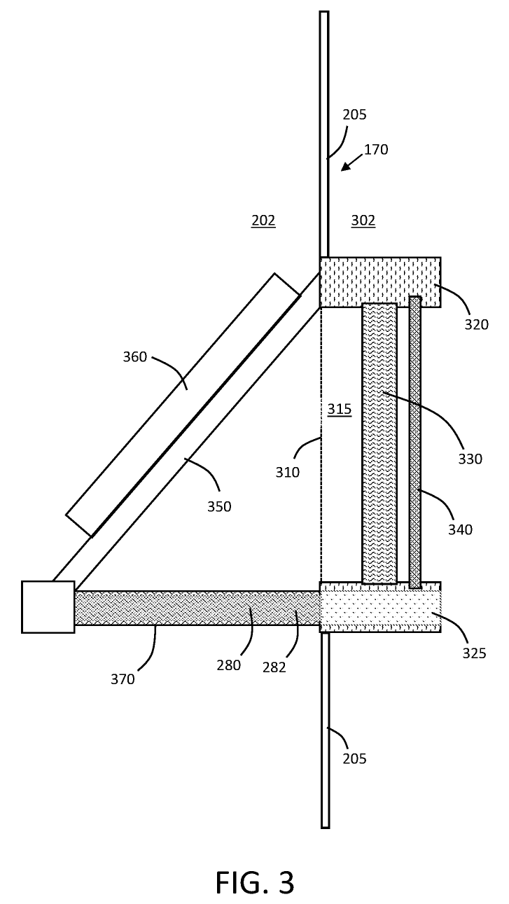

Referring now to FIG. 3, an embodiment of a battery enclosure 170 configured to receive desiccant in an easily removable manner is provided. The battery enclosure 170 encloses an interior volume 202. Specifically, the battery enclosure 170 separates the interior volume 202 from an external volume 302 outside of the battery enclosure 170.

In FIG. 3, a sidewall 205 of the battery enclosure 170 is shown. The sidewall 205 may be part of the tray 204 or the cover 206 (see FIG. 2), or may interconnect the tray 204 and the cover 206.

In FIG. 3, a vent 310 is formed in the sidewall 205. As shown, a box structure 320 may surround the vent 310 and be connected to the sidewall 205. The vent 310 and box structure 320 define an airflow channel 315. Further, a membrane 330 may extend across the airflow channel 315. As shown, a spark arrestor 340 may also extend across the airflow channel 315.

On the internal side of the vent 310, a baffle 350 is provided. As shown, a cooler 360 such as a Peltier cooler or a thermal electric cooler may be located on the backside of the baffle 350. Further, a mesh 370 such as a metal mesh 370 extends across the airflow channel 315.

The baffle 350 is provided to redirect the direction of airflow. The baffle 350 may be metal or another thermally conductive material. The cooler 360 cools the baffle 350. As a result, humid air passing through the vent 315 into the interior volume 202 is cooled by the baffle 350 and water condenses on to the baffle 350. The water then may trickle downward under the force of gravity onto the mesh 370.

In certain embodiments herein, desiccant 280 is located within the mesh 370. As a result, the desiccant 280 may absorb the water trickling down from the baffle 350. Further, the desiccant 280 may absorb moisture from the air passing through the mesh 370.

As shown in FIG. 3, the box 320 may be formed with a channel 325 through which the desiccant 280 may be inserted and removed from the mesh 370. The desiccant 280 may be located in a tray or tray-like cartridge 282 to assist in insertion and removal.

In the embodiment of FIG. 3, all air entering the battery enclosure 170 through the vent 310 must pass the desiccant 280 located in the mesh 370.

Additionally or alternatively, the desiccant 280 may be an extension of the cooled baffle 350. Such an arrangement adds additional cold surface area to contact moist air entering the battery pack. In such an embodiment, the mesh 370 may be locating before or after the desiccant 280, or the mesh 370 could be a cage within which the desiccant cartridge is located.

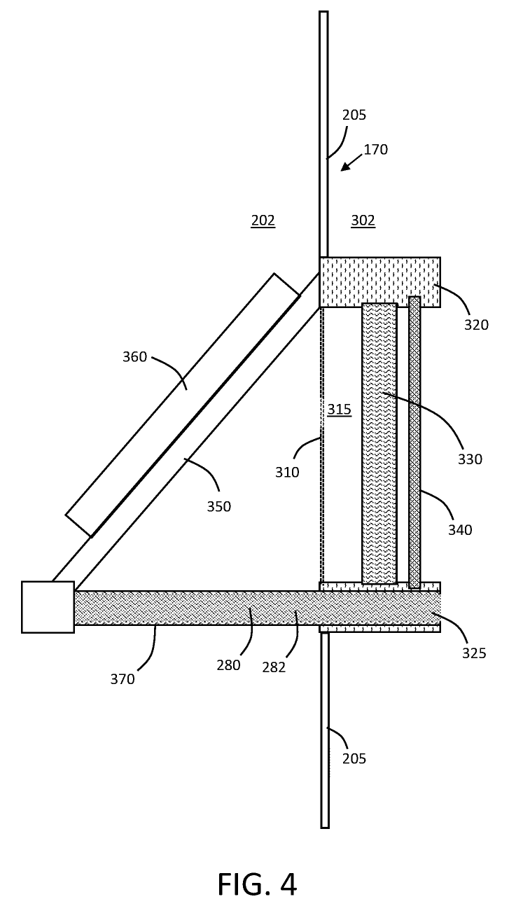

Referring now to FIG. 4, an embodiment of a battery enclosure 170 configured to receive desiccant in an easily removable manner is provided. The battery enclosure 170 encloses an interior volume 202. Specifically, the battery enclosure 170 separates the interior volume 202 from an external volume 302 outside of the battery enclosure 170.

In FIG. 4, a sidewall 205 of the battery enclosure 170 is shown. The sidewall 205 may be part of the tray 204 or the cover 206, or may interconnect the tray 204 and the cover 206.

In FIG. 4, a vent 310 is formed in the sidewall 205. As shown, a box structure 320 may surround the vent 310 and be connected to the sidewall 205. The vent 310 and box structure 320 define an airflow channel 315. Further, a membrane 330 may extend across the airflow channel 315. As shown, a spark arrestor 340 may also extend across the airflow channel 315.

On the internal side of the vent 310, a baffle 350 is provided. As shown, a cooler 360 such as a Peltier cooler or a thermal electric cooler may be located on the backside of the baffle 350. Further, a mesh 370 such as a metal mesh 370 extends across the airflow channel 315.

The baffle 350 is provided to redirect the direction of airflow. The baffle 350 may be metal or another thermally conductive material. The cooler 360 cools the baffle 350. As a result, humid air passing through the vent 315 into the interior volume 202 is cooled by the baffle 350 and water condenses on to the baffle 350. The water then may trickle downward under the force of gravity onto the mesh 370.

In embodiments herein, desiccant 280 is located within the mesh 370. As a result, the desiccant 280 may absorb the water trickling down from the baffle 350. Further, the desiccant 280 may absorb moisture from the air passing through the mesh 370.

As shown in FIG. 4, the box 320 may be formed with a channel 325 through which the desiccant 280 may be inserted and removed from the mesh 370. The desiccant 280 may be located in a tray or tray-like cartridge 282 to assist in insertion and removal.

In the embodiment of FIG. 4, all air entering the battery enclosure 170 through the vent 310 must pass the desiccant 280 located in the mesh 370.

Referring now to FIG. 5, an embodiment of a battery enclosure 170 configured to receive desiccant in an easily removable manner is provided. The battery enclosure 170 encloses an interior volume 202. Specifically, the battery enclosure 170 separates the interior volume 202 from an external volume 302 outside of the battery enclosure 170.

In FIG. 5, a sidewall 205 of the battery enclosure 170 is shown. The sidewall 205 may be part of the tray 204 or the cover 206, or may interconnect the tray 204 and the cover 206.

In FIG. 5, a vent 310 is formed in the sidewall 205. As shown, a box structure 320 may surround the vent 310 and be connected to the sidewall 205. The vent 310 and box structure 320 define an airflow channel 315. Further, a membrane 330 may extend across the airflow channel 315. As shown, a spark arrestor 340 may also extend across the airflow channel 315.

On the internal side of the vent 310, a baffle 350 is provided. The baffle 350 is provided to redirect the direction of airflow. The baffle 350 may be metal or another thermally conductive material.

Further, a closable baffler 390 extends across the airflow channel 315.

In embodiments herein, desiccant 280 is disposed across the airflow channel 315 within the box 320. As a result, the desiccant 280 may absorb moisture entering the battery enclosure 170 through the vent 310. Specifically, all air entering the battery enclosure 170 through the vent 310 must pass the desiccant 280.

In the embodiment of FIG. 5, when the desiccant 280 needs to be replaced, the closable baffle 390 closes. Rather than remove the desiccant 280, the desiccant 280 is regenerated by heating the desiccant 280 to evaporate the water therein. Because baffle 390 is closed, the evaporate water does not enter the battery enclosure 170. After sufficient water is evaporated and diffuses into the external environment 302, the baffle 390 may be re-opened. This regeneration process may be operated by the controller of FIG. 1.

Further, it is noted that during a thermal event, the baffle 390 may open fully or may disintegrate to allow a maximum flow of gas outward through the vent 310.

In each of the embodiments herein, the desiccant may be reached by a technician without disconnecting or removing the battery module. For example, in the embodiment of FIG. 2, the desiccant may be inserted and removed from the vehicle cabin. In the embodiments of FIGS. 3-4, the desiccant may inserted and removed by lifting the vehicle and accessing the exterior side of the vent. In FIG. 5, though designed for regeneration rather than replacement, the desiccant may be reached by lifting the vehicle and accessing the exterior side of the vent.

In certain embodiments herein, desiccant cartridges integrated into RESS pack to vehicle floor stanchions (structural elements) making the stanchion multi-functional. The cartridges can be serviced from cabin interior, and may have a color indicating feature.

In certain embodiments herein, the desiccant stanchions have design features to engage with the cabin floor to prevent gas leak into the cabin.

In certain embodiments herein, in addition to existing structural elements, desiccant cartridges can also be located at high voltage locations such as front and rear headers, and BDU connects identified as high risk for loss of isolation (LOI).

Further, in certain embodiments, desiccant cartridges may be integrated into the vent sub-assembly with or without desiccant regenerating elements.

In certain embodiments, desiccant cartridges can be integrated with drain plugs on bottom tray of RESS packs.

In certain embodiments, the amount of desiccant provided in the battery enclosure may be based on high humid environments and allowable ingress through vents per day, to achieve a target time based on service.

In certain embodiments, the processor calculates that the desiccant should be replaced or regenerated, based on an amount of the desiccant located within the interior volume of the battery enclosure, based on a performance efficiency of the desiccant, based on an external humidity of an external environment, and based on a period of time that the battery pack has been exposed to the external environment. The amount of desiccant located within the interior volume of the battery enclosure may be inputted by a technician or sensed by a sensor. The performance efficiency of the desiccant may be inputted by a technician, or the desiccant may be identified by the technician and the processor may look up the performance efficiency of the identified desiccant. The external humidity of the external environment may be sensed by a sensor. The period of time may be monitored by the processor.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for reducing humidity in a battery pack, the method comprising:
locating a battery module within an interior volume of a battery enclosure having a floor and configured to be enclosed with a cover;
locating a desiccant within the interior volume of the battery enclosure; and
absorbing water from air within the interior volume of the battery enclosure.

2. The method of claim 1, further comprising:
removing the desiccant from the interior volume of the battery enclosure; and
inserting fresh desiccant into the interior volume of the battery enclosure,
wherein the battery module remains within the interior volume of the enclosure while removing the desiccant and inserting the fresh desiccant.

3. The method of claim 1, wherein:
the floor of the enclosure is supported by a lower cross beam;
a stanchion is mounted to the lower cross beam and extends through the interior volume of the battery enclosure to an upper cross beam;
the stanchion includes a stanchion wall surrounding a channel;
the stanchion wall is formed with at least one port providing fluid communication between the channel and the interior volume of the battery enclosure; and
locating the desiccant within the interior volume of the battery enclosure comprises inserting the desiccant into the channel of the stanchion.

4. The method of claim 3, wherein an indicator in contact with the desiccant is visible at a top end of the stanchion, and wherein the method further comprises providing an indication, external of the battery enclosure, with the indicator that the desiccant should be replaced.

5. The method of claim 4, wherein the battery pack is located in a vehicle having a cabin with a cabin floor, wherein the indicator is visible at the cabin floor, and wherein the method further comprises:
pulling the desiccant from the channel of the stanchion into the vehicle cabin; and
inserting fresh desiccant into the channel of the stanchion from the vehicle cabin.

6. The method of claim 1, further comprising:
calculating with a processor that the desiccant should be replaced, based on an amount of the desiccant located within the interior volume of the battery enclosure, based on a performance efficiency of the desiccant, based on an external humidity of an external environment, and based on a period of time that the battery pack has been exposed to the external environment.

7. The method of claim 6, wherein the processor activates an alert providing an indication that the desiccant should be replaced.

8. The method of claim 1, wherein the enclosure is formed with a vent defining an airflow channel, and wherein locating the desiccant within the interior volume of the battery enclosure comprises locating the desiccant across the airflow channel.

9. The method of claim 8, further comprising:
locating a baffle within the battery enclosure to redirect a flow of air into the interior volume through the vent; and
cooling the baffle to condense water from the air.

10. The method of claim 8, further comprising:
locating a closable baffle across the airflow channel;
determining that the desiccant needs to be regenerated;
closing the closable baffle to close the airflow channel;
heating the desiccant to evaporate water therefrom and regenerate the desiccant; and
re-opening the closable baffle after the desiccant is regenerated.

11. A battery humidity reduction system for a vehicle, the system comprising:
a battery enclosure;
a battery module located within the battery enclosure;
a lower cross beam connected to a structure of the vehicle and located below the battery enclosure;
an upper cross beam connected to the structure of the vehicle and located above the battery enclosure;
a structural stanchion interconnected between the lower cross beam and the upper cross beam, wherein the structural stanchion passes through the battery enclosure, wherein the structural stanchion is formed with a stanchion wall surrounding an inner channel, and wherein the stanchion wall is formed with a window; and
desiccant located in a desiccant cartridge configured to be inserted into and withdrawn from the inner channel of the structural stanchion.

12. The battery humidity reduction system of claim 11, wherein the desiccant cartridge holds an indicator that provides a visual indication when the desiccant needs to be replaced.

13. The battery humidity reduction system of claim 12, wherein the battery enclosure is located below a vehicle cabin floor of a vehicle cabin, and wherein the system further comprises an opening in the vehicle cabin floor configured for insertion of the cartridge from the vehicle cabin into the inner channel of the stanchion.

14. The battery humidity reduction system of claim 13, wherein the indicator is visible from the vehicle cabin when the desiccant is located in the inner channel.

15. A vehicle comprising:
an electric propulsion system;
a battery module;
a battery enclosure, wherein the battery module is received within the battery enclosure, and wherein the battery enclosure is formed with a vent that defines an airflow channel; and
desiccant extending across the airflow channel.

16. The vehicle of claim 15, further comprising a baffle within the battery enclosure to redirect a flow of air into the interior volume through the vent.

17. The vehicle of claim 16, further comprising a cooler in contact with the baffle and configured to cool the baffle to cause condensation of water thereon.

18. The vehicle of claim 17, further comprising a mesh extending across the airflow channel and located below the baffle, wherein the mesh is configured to collect water from the baffle, and wherein the desiccant is located within the mesh.

19. The vehicle of claim 15, further comprising a closable baffle extending across the airflow path, wherein the closable baffle is located between the desiccant and a remaining internal volume of the battery enclosure.

20. The vehicle of claim 19, further comprising a controller configured to:
determine when the desiccant needs to be regenerated;
close the closable baffle;
activate heating of the desiccant to evaporate water therefrom to regenerate the desiccant; and
re-open the closable baffle after regeneration of the desiccant.
